(19) United States
(12) Patent Application Publication
(10) Pub. No.: US 2004/0042525 A1
(43) Pub. Date: Mar. 4, 2004

(54) Method and apparatus for generating a coherent laser beam and method for making a hologram to be used therein

(75) Inventor: Herman Leonard Offerhaus, Diemen (NL)

Correspondence Address: PEACOCK MYERS AND ADAMS P C, P O BOX 26927, ALBUQUERQUE, NM, 871256927

(73) Assignee: Stichting voor de Technische Wetenschappen, Utrecht (NL)

(21) Appl. No.: 10/657,063

(22) Filed: Sep. 3, 2003

Related U.S. Application Data
(63) Continuation of application No. PCT/NL02/00223, filed on Apr. 5, 2002.

(30) Foreign Application Priority Data
Apr. 5, 2001 (NL) 1017779

(51) Int. Cl. H01S 3/082; H01S 3/08

(52) U.S. Cl. 372/97; 372/98

(57) ABSTRACT

An apparatus for generating a coherent laser beam from an emission of a series of diode lasers, comprising at least one row of source diodes and a system for transforming the primary light emission emitted by the source diodes into secondary coherent light emission, wherein the system for transforming the primary emission into secondary coherent light emission includes a hologram, which comprises an image of an interference pattern of the primary light emission and the secondary coherent light emission, so that when illuminating the hologram with the primary light emission, the hologram reflects the secondary coherent light emission and in that a mirror is provided in the path of the secondary coherent light emission, which reflects at least some of the secondary coherent light emission via the hologram to the diode lasers.

The invention relates in the first place to a method and apparatus for generating a coherent laser beam from an emission of a series of diode lasers, comprising at least one row of source diodes and a system for transforming the primary light emission emitted by the source diodes into secondary coherent light emission.

Such an apparatus is known from the European patent application EP-A-0 997 997.

The known apparatus comprises a diode array for generating the primary light emission and a series of mirrors, two of which form a resonator while at least one of the mirrors has a non-spherical surface serving as correction organ for the emission. In addition to the resonator a secondary element is provided for transforming the light emission into the desired amplitude- and phase-distribution.

It is the object of the invention to provide an alternative apparatus and method for generating the coherent laser beam, wherein the means used for this purpose are relatively inexpensive so that a high power laser with high intensity can be made available at relatively low costs.

To this end the apparatus according to the invention is characterized in that the system for transforming the primary emission into secondary coherent light emission includes a hologram, which comprises an image of an interference pattern of the primary light emission and the secondary coherent light emission, so that when illuminating the hologram with the primary light emission, the hologram reflects the secondary coherent light emission, and in that a mirror is provided in the path of the secondary coherent light emission, which reflects at least some of the secondary coherent light emission via the hologram to the diode lasers.

In this way the secondary coherent light emission reflected to the hologram can act as feedback signal for the diode lasers, so that they become locked in their phase relations, which will eventually provide the secondary coherent light emission. Most of the secondary coherent light emission that is not needed for reflection to the hologram may then be usefully applied for the desired use.

In general the method according to the invention for generating a coherent laser beam from light emission of a series of diode lasers is therefore characterized in that the primary light emission which originates from a series of diode lasers is transformed into secondary coherent light emission by using the primary light emission to illuminate a hologram containing an image of an interference pattern of the primary light emission and the secondary coherent light emission, and in that at least some of the secondary coherent light emission is reflected to the hologram for generating tertiary light emission beaming contrary to the primary light emission but at equal phase relations, and wherein the tertiary light emission is used to provide a feedback signal to the diode lasers.

The invention also relates to a method for making a hologram that is suitable to be used in a method and apparatus as explained above. This method comprises the generation of primary light emission by means of diode lasers, after which the primary light emission is directed at a recording medium which allows at least some of the light emission to pass through for recording an interference pattern, after which the primary light emission that has passed through the recording medium is concentrated and directed at a photorefractive crystal that is fed by a pump beam in a self-pumped configuration, or at a crystal that is fed by a pump beam such that the photorefractive crystal returns light that is phase-conjugated with the primary light emission to the diode array in order to provide the diode lasers with a feedback signal, while a reference signal is directed at the recording medium so that together with the primary light emission, it can form the interference pattern.

The primary light emission that has passed through the recording medium may be concentrated simply by means of a lens.

The invention will now be further elucidated with reference to the drawing which in:

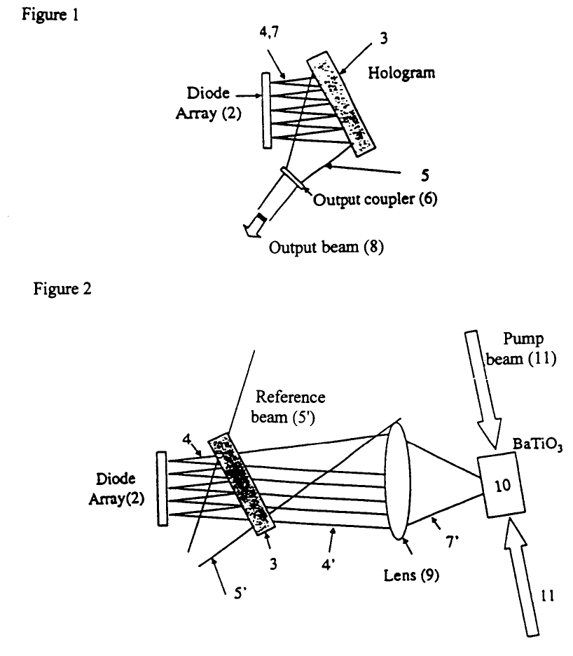

FIG. 1 schematically shows the apparatus according to the invention for generating a coherent laser beam, and in

FIG. 2 shows an apparatus for making a hologram according to the invention.

Identical parts in the figures are identified by the same reference numbers.

Referring first to FIG. 1, reference number 1 generally indicates the apparatus for generating a coherent laser beam according to the invention. This apparatus 1 comprises a series of diode lasers (2), for example, a row of diodes, or several stacked rows of such diodes. The primary light emitted by these diodes (2) may contain a considerable power. However, the difficulty is to transform this light emission into a coherent laser beam so as to also obtain a high intensity. For this purpose the invention uses a hologram (3) comprising an interference pattern of the primary light (4) emitted by the diode array (2) and the sought secondary coherent light emission (5). In the path of the coherent light emission (5) a mirror (6) is placed that reflects some of the coherent light emission (5) back to the hologram (3). The result is that by means of the hologram (3) this secondary light emission generates tertiary light emission (7) that corresponds to the primary light emission (4), which while beaming contrary to the primary light emission (4) has the same phase relation. The tertiary light emission (7) can thus serve as feedback signal for the diodes (2) of the diode array, thereby realising phase-locking of the primary light emission (4), which in connection with the hologram (3) provides the secondary coherent light emission (5). The secondary light emission (5) that is not reflected by the mirror (6) but passes through, may be conducted away by means of a suitable conductor, for example, a fibre channel (8) and be used for the desired application.

Referring to FIG. 2, the method is explained of making a hologram (3) that is suitable to be used in the above-mentioned method and apparatus according to FIG. 1 for generating a coherent laser beam.

The hologram (3) is made by generating primary light emission (4) with the aid of the diodes (2) of the diode array, and directing this at a recording medium (3) that is to form the hologram, and that allows at least some of the primary light emission (4) to pass through, and which serves to record an interference pattern to be used in the apparatus according to FIG. 1. To this end the primary light emission (4′) that has passed through the recording medium (3) is concentrated, for example, by means of a lens (9) and directed at a photorefractive crystal (10) arranged in a self-pumping configuration or—as shown in FIG. 2—is additionally fed by a pump beam (11) such that the photorefractive crystal (10) returns light (7′) that is phase-conjugated with the primary light emission (4′) back to the diode array in order to provide a feedback signal for the diode lasers (2), while a reference beam (5′) is directed at the recording medium (3) to form, together with the primary light emission (4), the desired interference pattern to be recorded in the hologram.

Various suitable materials may be used for the crystal (10), for example, a crystal made from the material BaTiO₃.

The recording medium (3) used for making the hologram may be polymers that are cured by the influence of light or a photographic process followed by an etching process; it is also possible to use quartz that is preheated to its first structural transition at 570° C. The interference pattern is then recorded by rapid cooling of the material to below this temperature.

It will be clear from the above, that in order to match the typifying pattern of the primary light emission emitted by this series of diodes (2), the hologram (3) needs in principle to be fabricated separately for each individual series of diodes. It is therefore a particular advantage of the invention that a great degree of independence is achieved with respect to imperfections when producing the series of diodes (2); especially the effect of the so-called diode “smile”, a curved surface of the diode array, is avoided.

What is claimed is:

1. An apparatus for generating a coherent laser beam from an emission of a series of diode lasers, comprising at least one row of source diodes and a system for transforming the primary light emission emitted by the source diodes into secondary coherent light emission, wherein the system for transforming the primary emission into secondary coherent light emission includes a hologram, which comprises an image of an interference pattern of the primary light emission and the secondary coherent light emission, so that when illuminating the hologram with the primary light emission, the hologram reflects the secondary coherent light emission, and wherein a mirror is provided in the path of the secondary coherent light emission which reflects at least some of the secondary coherent light emission via the hologram to the diode lasers.

2. A method for generating a coherent laser beam from an emission of a series of diode lasers, comprising the generation of primary light emission with the aid of the diode lasers after which the primary light emission is transformed into secondary coherent light emission by using the primary light emission to illuminate a hologram containing an image of an interference pattern of the primary light emission and the secondary coherent light emission and by reflecting at least some of the secondary coherent light emission to the hologram for the generation of tertiary light emission, which beams contrary to the primary light emission but has a same phase relation, and wherein the tertiary light emission is used as provider of a feedback signal for the diode lasers.

3. A method for making a hologram that is suitable to be used in a method and apparatus generating a coherent laser beam from an emission of a series of diode lasers, comprising the generation of primary light emission with the aid of the diode lasers, after which the primary light emission is directed at an at least partly permeable recording medium for recording an interference pattern, after which the primary light emission that has passed through the recording medium is concentrated and directed at a photoreflective crystal in a self-pumped configuration, or at a crystal that is fed by a pump beam such that the photoreflective crystal returns a light emission that is phase-conjugated with the primary light emission to the diode array in order to provide the diode lasers with a feedback signal, while a reference signal is directed at the recording medium so that together with the primary light emission, it can form the interference pattern.

4. A method according to claim 3, wherein the primary light emission that has passed through the recording medium is concentrated by means of a lens.
